(19) United States
(12) Patent Application Publication
(10) Pub. No.: US 2011/0012882 A1
(43) Pub. Date: Jan. 20, 2011

(54) SOURCE DRIVER AND DISPLAY DEVICE HAVING THE SAME

(76) Inventors: JI-YONG JEONG, Seoul (KR); Jeung-Tae Park, Yongin-si (KR); Seung-Hwan Baek, Hwaseong-si (KR); Soo-Ik Cha, Suwon-si (KR)

Correspondence Address: F. CHAU & ASSOCIATES, LLC, 130 WOODBURY ROAD, WOODBURY, NY, 11797, US

(21) Appl. No.: 12/837,655

(22) Filed: Jul. 16, 2010

(30) Foreign Application Priority Data
Jul. 16, 2009 (KR) 10-2009-0065086

(51) Int. Cl. G06F 3/038; G09G 3/36

(52) U.S. Cl. 345/211; 345/87

(57) ABSTRACT

A display device includes a source driver. The source driver includes a power supply and a gamma voltage output unit. The power supply generates a power supply voltage and a plurality of reference voltages. The power supply voltage is stabilized in a power-up operating mode. The plurality of reference voltages are stabilized after a stabilization time period has elapsed in the power-up operating mode. The gamma voltage output unit generates a plurality of gamma voltages using the power supply voltage for the stabilization time period in the power-up operating mode, and generates the plurality of gamma voltages using the plurality of reference voltages after the stabilization time period has elapsed.

### CROSS-REFERENCE TO RELATED APPLICATION

This application claims under 35 U.S.C. §119 priority to and the benefit of Korean Patent Application No. 10-2009-65086, filed on Jul. 16, 2009, the entire content of which is incorporated by reference herein.

### BACKGROUND

1. Technical Field

The present disclosure relates to display devices, and, more particularly, to a source driver of a display device.

2. Discussion of Related Art

Recently, various flat panel devices such as liquid crystal displays (LCDs) have been widely used as display devices. A flat panel device generally includes a display panel, a controller, a gate driver and a source driver.

The source driver is a circuit that drives a data line of the display panel using voltages corresponding to a data signal received from the controller. The source driver generates a plurality of gamma voltages, and selects at least one of the gamma voltages to drive the data line using a decoder. Unstable voltages applied to the decoder during a power-up operating mode can damage the source driver.

### SUMMARY

In accordance with exemplary embodiments of the present inventive concept a source driver, and a display device including the source driver, capable of preventing damage to a decoder during a power-up operating mode, are provided.

An exemplary embodiment of a gamma voltage generation apparatus for a display device is also provided.

In accordance with an exemplary embodiment a source driver includes a power supply configured to generate a power supply voltage and a plurality of reference voltages, the power supply voltage being stabilized in a power-up operating mode and the plurality of reference voltages being stabilized after a stabilization time period has elapsed in the power-up operating mode. A gamma voltage output unit is configured to generate a plurality of gamma voltages using the power supply voltage for the stabilization time period in the power-up operating mode, and to generate the plurality of gamma voltages using the plurality of reference voltages after the stabilization time period has elapsed.

In accordance with an exemplary embodiment a display device includes a controller configured to generate a gate control signal and a data signal. A gate driver is configured to drive gate lines in response to the gate control signal. A source driver is configured to drive data lines in response to the data signal. A display panel is configured to display image information in response to signals applied to the gate lines and the data lines. The source driver includes: a power supply configured to generate a power supply voltage and a plurality of reference voltages, the power supply voltage being stabilized in a power-up operating mode and the plurality of reference voltage being stabilized after a stabilization time period has elapsed in the power-up operating mode, and a gamma voltage output unit configured to generate a plurality of gamma voltages using the power supply voltage for the stabilization time period in the power-up operating mode, and to generate the plurality of gamma voltages using the plurality of reference voltages after the stabilization time period has elapsed.

The source driver may further include a decoding unit configured to select at least one voltage of the plurality of gamma voltages in response to a data signal.

The source driver may further include a decoding unit having a plurality of decoders, the decoders being configured to select at least one voltage of the plurality of gamma voltages and drive a corresponding data line of the data lines in response to the data signal.

The power supply may generate the plurality of reference voltages using the power supply voltage.

The gamma voltage output unit may include a control signal generator configured to generate a control signal in response to a level of at least one reference voltage of the plurality of reference voltages, and a gamma voltage generator configured to generate the plurality of gamma voltages using the power supply voltage or the plurality of the reference voltages in response to the control signal.

The control signal generator may include an internal reference voltage generator configured to generate an internal reference voltage based upon the power supply voltage, and a comparing unit configured to compare a reference voltage of the plurality of reference voltages and the internal reference voltage to output the control signal that is activated when a magnitude of the reference voltage is greater than the internal reference voltage.

The gamma voltage generator may include a converter configured to generate a plurality of internal gamma voltages based upon the plurality of reference voltages, a resistor string including a plurality of resistors, that is configured to output the gamma voltages at each of the nodes between two of the plurality of resistors, and a buffer unit configured to apply the power supply voltage to a first end of the resistor string and to apply a ground voltage to a second end of the resistor string, or to apply each of the plurality of internal gamma voltages to a corresponding node of the nodes between two of the plurality of resistors of the resistor string in response to the control signal.

The gamma voltage generator may include a converter configured to generate first internal gamma voltages having relatively high voltage levels and second internal gamma voltages having relatively low voltage levels based upon the plurality of reference voltages, a resistor string including a plurality of resistors, that is configured to output the gamma voltages at each of the nodes between two of the plurality of resistors, a first selecting unit configured to select the first internal gamma voltages or the power supply voltage in response to the control signal, a second selecting unit configured to select the second internal gamma voltages or a ground voltage in response to the control signal, and a buffer unit configured to apply voltages output from the first selecting unit and the second selecting unit to a corresponding node of the nodes between two of the plurality of resistors of the resistor string.

In accordance with an exemplary embodiment a gamma voltage generation apparatus for a display device includes a supply voltage generator that provides a power supply voltage that is stabilized to a predetermined power supply voltage level during substantially an entire power-up operating mode. A reference voltage generator is coupled between an output of the supply voltage generator and ground. The reference voltage generator includes a plurality of resistors coupled in series between the output of the supply voltage generator and ground, and a plurality of capacitors, each capacitor coupled between a respective pair of the resistors and ground. A respective reference voltage is output from each respective node between two of the plurality of resistors. Each reference voltage reaches a respective reference voltage level during a respective stabilization time period during the power-up operating mode. A gamma voltage generator generates a plurality of gamma voltages using the power supply voltage or the reference voltages. A control signal generator controls the use of the power supply voltage by the gamma voltage generator prior to a predetermined time point at which the levels of the reference voltages are stabilized, and controls the use of the reference voltages by the gamma voltage generator after the predetermined time point has passed.

The stabilization time period for each of the reference voltages may be different from each other.

Each of the capacitors has substantially the same capacitance.

### BRIEF DESCRIPTION OF THE DRAWINGS

Exemplary embodiments are described in further detail below with reference to the accompanying drawings.

FIG. 1 is a block diagram of a source driver according to an exemplary embodiment.

FIG. 2 is a circuit diagram illustrating an exemplary embodiment of a power supply of the source driver shown in FIG. 1.

FIG. 3 is a circuit diagram illustrating an exemplary embodiment of a control signal generator of the source driver shown in FIG. 1.

FIG. 4 is a circuit diagram illustrating an exemplary embodiment of a gamma voltage generator of the source driver shown in FIG. 1.

FIG. 5 is a circuit diagram illustrating an exemplary embodiment of a voltage generator of the gamma voltage generator of the source driver shown in FIG. 4.

FIGS. 6(a) and 6(b) are timing diagrams for explaining the operation of the power supply of FIG. 2 and the gamma voltage generator of FIG. 4, respectively.

FIG. 7 is a circuit diagram illustrating an exemplary embodiment of a voltage generator of the gamma voltage generator of the source driver shown in FIG. 4.

FIG. 8 is a circuit diagram illustrating an exemplary embodiment of a P decoder of a decoding unit of the source driver shown in FIG. 1.

FIG. 9 is a block diagram illustrating an exemplary embodiment of a display device including the source driver according to an exemplary embodiment.

### DETAILED DESCRIPTION OF THE EMBODIMENTS

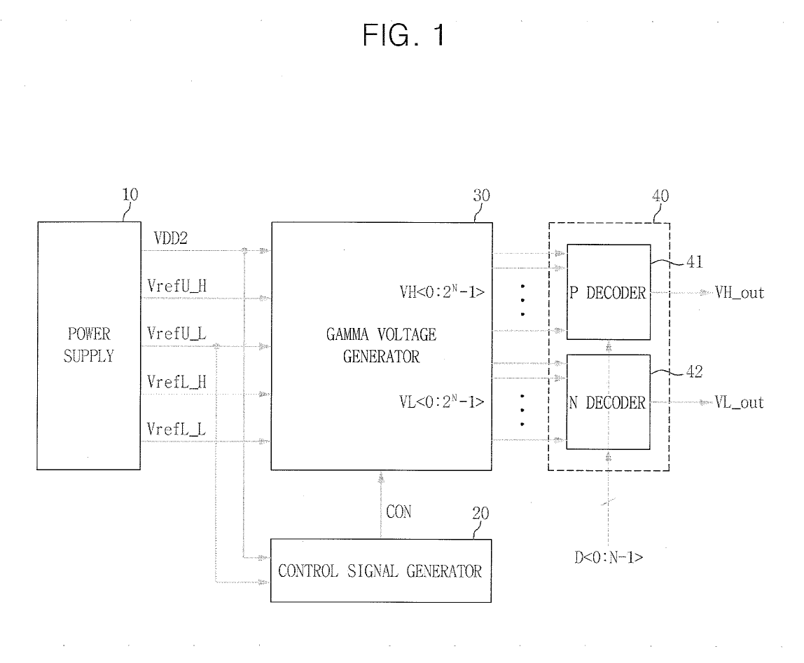

FIG. 1 is a block diagram illustrating a source driver according to an exemplary embodiment. The source driver includes a power supply 10, a control signal generator 20, a gamma voltage generator 30 and a decoding unit 40. The decoding unit 40 includes a P decoder 41 and an N decoder 42.

The power supply 10 generates a power supply voltage VDD2 and four reference voltages VrefU_H, VrefU_L, VREFL_H, VrefL_L using the power supply voltage VDD2. In a power-up operating mode, the power supply voltage VDD2 is stabilized to a predetermined power supply voltage level, and each of the four reference voltages VrefU_H, VrefU_L, VREFL_H, VrefL_L is stabilized to a respective reference voltage level after a predetermined stabilization time period. The stabilization time period may be different for each of the four reference voltages VrefU_H, VrefU_L, VREFL_H, VrefL_L. The four reference voltages VrefU_H, VrefU_L, VREFL_H, VrefL_L may be divided into first reference voltages VrefU_H, VrefU_L having relatively high voltage levels and second reference voltages VrefL_H, VrefL_L having relatively low voltage levels.

The control signal generator 20 senses a level of the reference voltage to generate the control signal CON. The control signal generator 20 may sense a level of a reference voltage (i.e., VrefU_L) of the four reference voltages VrefU_H, VrefU_L, VREFL_H, VrefL_L to generate the control signal CON.

The gamma voltage generator 30 generates a plurality of gamma voltages VH<0:2^{N}−1> and VL<0:2^{N}−1> using the power supply voltage VDD2 or the four reference voltages VrefU_H, VrefU_L, VREFL_H, VrefL_L in response to the control signal CON. The gamma voltages VH<0:2^{N}−1>, VL<0:2^{N}−1> may be divided into first gamma voltages VH<0:2^{N}−1> having relatively high voltage levels and second gamma voltages VL<0:2^{N}−1> having relatively low voltage levels. For example, the gamma voltage generator 30 may generate the first gamma voltages VH<0:2^{N}−1> using the first reference voltages VrefU_H, VrefU_L and generate the second gamma voltages VL<0:2^{N}−1> using the second reference voltages VrefL_H, VrefL_L.

The decoding unit 40 generates a first output gamma voltage VH_out and a second output gamma voltage VL_out in response to a data signal D<0: N−1>. The P decoder 41 receives the first gamma voltages VH<0:2^{N}−1>, selects one of the first gamma voltages VH<0:2^{N}−1> and outputs the selected voltage as the first output gamma voltage VH_out. The N decoder 42 receives the second gamma voltages VL<0:2^{N}−1>, selects one of the second gamma voltages VL<0:2^{N}−1> and outputs the selected voltage as the second output gamma voltage VL_out.

In FIG. 1, the case where power supply 10 outputs the four reference voltages VrefU_H, VrefU_L, VREFL_H, VrefL_L is illustrated as an example, but the number of reference voltages output from the power supply 10 may vary as needed.

Further, In FIG. 1, one decoding unit is shown for convenience of explanation, but the source driver may include a plurality of decoding units driving corresponding data lines. In this case, the gamma voltage generator 30 would supply the gamma voltages VH<0:2^{N}−1>, VL<0:2^{N}−1> to each of the plurality of decoders, and each of the plurality of decoders would select one of the gamma voltages VH<0:2^{N}−1>, VL<0:2^{N}−1> to drive the corresponding data lines in response to the corresponding data signal.

Although not shown, the decoding unit 40 may further include an output unit that receives the first output gamma voltage VH_out and the second output gamma voltage VL_out and outputs an output gamma voltage driving data lines. In this case, the output unit would operate in response to an additional data signal other than the data signal D<0:N−1> that is applied to the P decoder 41 and the N decoder 42. For example, the output unit would select and output the first output gamma voltage VH_out or the second output gamma voltage VL_out as an output gamma voltage in response to the additional data signal. Further, the output unit may select and output one of a plurality of voltages generated using the first output gamma voltage VH_out and/or the second output gamma voltage VL_out as an output gamma voltage in response to the additional data signal. Further, the output unit may include a driving circuit that drives data lines.

That is, the source driver according to the exemplary embodiment shown in FIG. 1 generates a plurality of gamma voltages using the power supply voltage up to a predetermined time point (e.g., a time point at which a level of the reference voltages VrefU_H, VrefU_L, VrefL_H, VrefL_L is stabilized to a predetermined level), and generates the plurality of gamma voltages using the plurality of reference voltages after the predetermined time point has passed in a power-up operating mode.

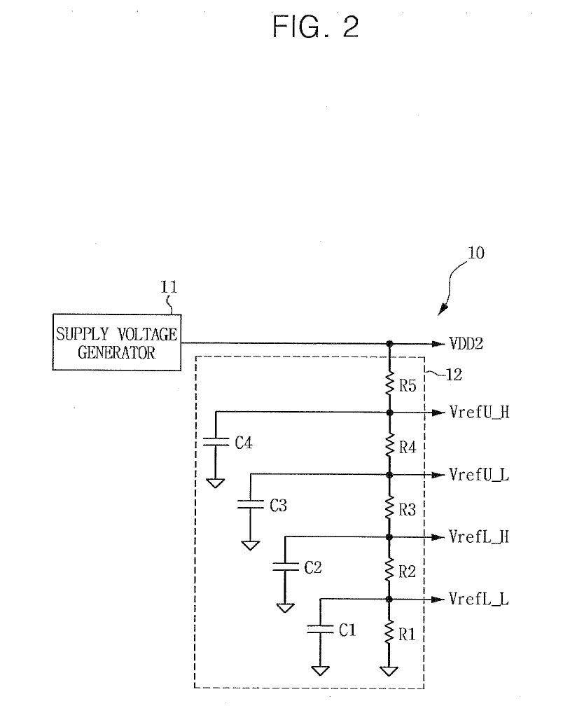

FIG. 2 is a circuit diagram illustrating an exemplary embodiment of a power supply 10 of the source driver shown in FIG. 1. The power supply 10 includes a supply voltage generator 11 and a reference voltage generator 12. The reference voltage generator 12 includes a plurality of resistors R1, R2, R3, R4, R5 coupled in series between an output terminal of the supply voltage generator 11 and the ground voltage, and a plurality of capacitors C1, C2, C3, C4 coupled between each of the plurality of resistors R1, R2, R3, R4, R5 and the ground voltage. Each of the four reference voltages VrefU_H, VrefU_L, VrefL_H, VrefL_L is output from each of the nodes between two of the plurality of resistors R1, R2, R3, R4, R5.

The supply voltage generator 11 generates the power supply voltage VDD2. The supply voltage generator 11 may include a DC-DC converter that converts an input voltage received from an exterior into the power supply voltage VDD2. In the power-up operating mode, the power supply voltage VDD2 output from the supply voltage generator 11 is stabilized to a predetermined voltage level after a relatively short time.

The reference voltage generator 12 receives the power supply voltage VDD2 and generates the four reference voltages VrefU_H, VrefU_L, VrefL_H, VrefL_L.

The four reference voltages VrefU_H, VrefU_L, VrefL_H, VrefL_L output from the reference voltage generator 12 are input to the gamma voltage generator 30, and the gamma voltage generator 30 generates the gamma voltages VH<0:2^{N}−1>, VL<0:2^{N}−1> using the four reference voltages VrefU_H, VrefU_L, VrefLH, VrefL_L. Therefore, the four reference voltages VrefU_H, VrefU_L, VrefL_H, VrefL_L need to have stable voltage levels. For this, the reference voltage generator 12 includes the capacitors C1, C2, C3, C4 coupled between each of the nodes at which the four reference voltages VrefU_H, VrefU_L, VrefL_H, VrefL_L are output and the ground voltage. Each of the capacitors C1, C2, C3, C4 may have a capacitance of about 100 nF.

In the power-up operating mode, each of the four reference voltages VrefU_H, VrefU_L, VrefL_H, VrefL_L output from the reference voltage generator 12 may be stabilized to a respective reference voltage level after the stabilization time period due to the capacitors C1, C2, C3, C4. The stabilization time periods for the four reference voltages VrefU_H, VrefU_L, VrefL_H, VrefL_L may have different values from each other. Although each of the four reference voltages VrefU_H, VrefU_L, VrefL_H, VrefL_L is stabilized after the stabilization time period having different values, each of the stabilization time periods for the four reference voltages VrefU_H, VrefU_L, VrefL_H, VrefL_L may have a much longer time than the time in which the power supply voltage VDD2 is stabilized.

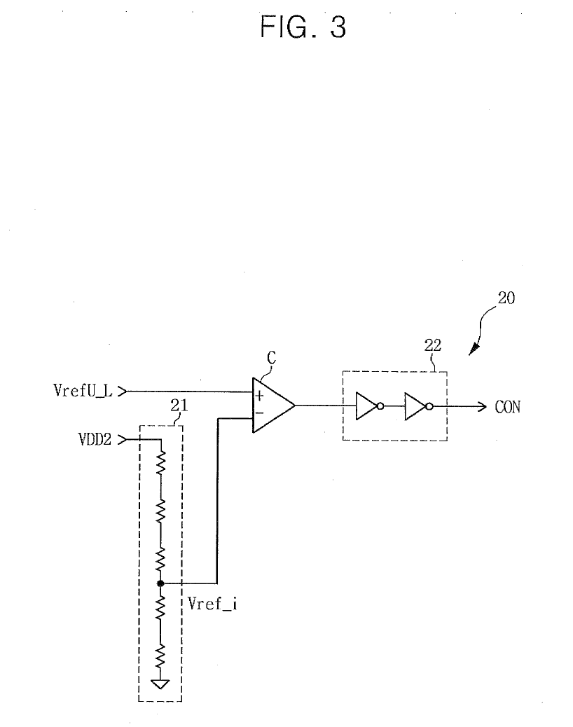

FIG. 3 is a circuit diagram illustrating an exemplary embodiment of a control signal generator 20 of the source driver shown in FIG. 1. The control signal generator 20 includes an internal reference voltage generator 21, a comparator C and a buffer 22.

The internal reference voltage generator 21 generates an internal reference voltage Vref_i based upon the power supply voltage VDD2. The internal reference voltage generator 21 may be a voltage divider that includes a plurality of resistors connected in series between a terminal to which the power supply voltage VDD2 is applied and the ground voltage.

The comparator C compares the internal reference voltage Vref_i and a reference voltage (e.g., VrefU_L) of the four reference voltages VrefU_H, VrefU_L, VrefL_H, VrefL_L to output the control signal CON. That is, the comparator C activates the control signal CON to a high level when a magnitude of the reference voltage VrefU_L is greater than the internal reference voltage Vref_i.

The buffer 22 buffers a signal output from the comparator C and outputs the buffered signal as the control signal CON.

As described above referring to FIG. 2, each of the reference voltages VrefU_H, VrefU_L, VrefL_H, VrefL_L is stabilized after a predetermined time in a power-up operating mode. Therefore, in the power-up operating mode, the control signal generator 20 shown in FIG. 3 outputs the control signal CON deactivated to a low level for the stabilization time period, which is the time until the reference voltage VrefU_L has reached the internal reference voltage Vref_i, and outputs the control signal CON activated to a high level after the stabilization time period.

In FIG. 3, the case where the control signal generator 20 detects a level of the reference voltage VrefU_L to output the control signal CON is illustrated as an example. However, the control signal generator 20 may output the control signal CON deactivated to a low level using a delay circuit or a counter in the power-up operating mode beforehand, and then may output the control signal CON activated to a high level after the stabilization time period.

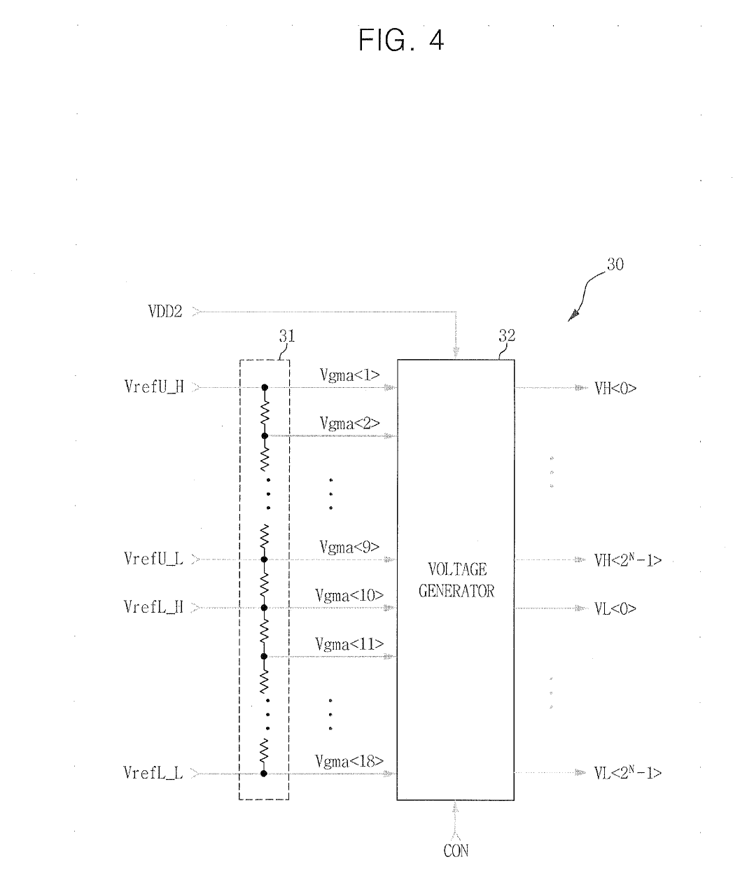

FIG. 4 is a circuit diagram illustrating an exemplary embodiment of a gamma voltage generator 30 of the source driver shown in FIG. 1. The gamma voltage generator 30 may include a converter 31 and a voltage generator 32. The converter 31 may include a plurality of resistors connected in series between the reference voltage VrefU_H and the reference voltage VrefL_L.

The converter 31 generates a plurality of internal gamma voltages Vgma<1:18> based upon the reference voltages output from the power supply 10. The converter 31 may generate first internal gamma voltages Vgma<1:9> having relatively high voltage levels using first reference voltages VrefU_H, VrefU_L and second internal gamma voltages Vgma<10:18> having relatively low voltage levels using second reference voltages VrefL_H, VrefL_L.

The voltage generator 32 generates the gamma voltages VH<0:2^{N}−1>, VL<0:2^{N}−1> using the power supply voltage VDD2 or the internal gamma voltages Vgma<1:18> in response to the control signal CON. For example, when the control signal CON is deactivated, the voltage generator 32 generates the gamma voltages VH<0:2^{N}−1>, VL<0:2^{N}−1> using the power supply voltage VDD2. When the control signal CON is activated, the voltage generator 32 generates the gamma voltages VH<0:2^{N}−1>, VL<0:2^{N}−1> using the internal gamma voltages Vgma<1:18>. Further, when generating the gamma voltages VH<0:2^{N}−1>, VL<0:2^{N}−1> using the internal gamma voltages Vgma<1:18>, the voltage generator 32 may generate the first gamma voltages VH<0:2^{N}−1> using the first internal gamma voltages Vgma<1:9> and generate the second gamma voltages VL<0:2^{N}−1> using the second internal gamma voltages Vgma<10:18>.

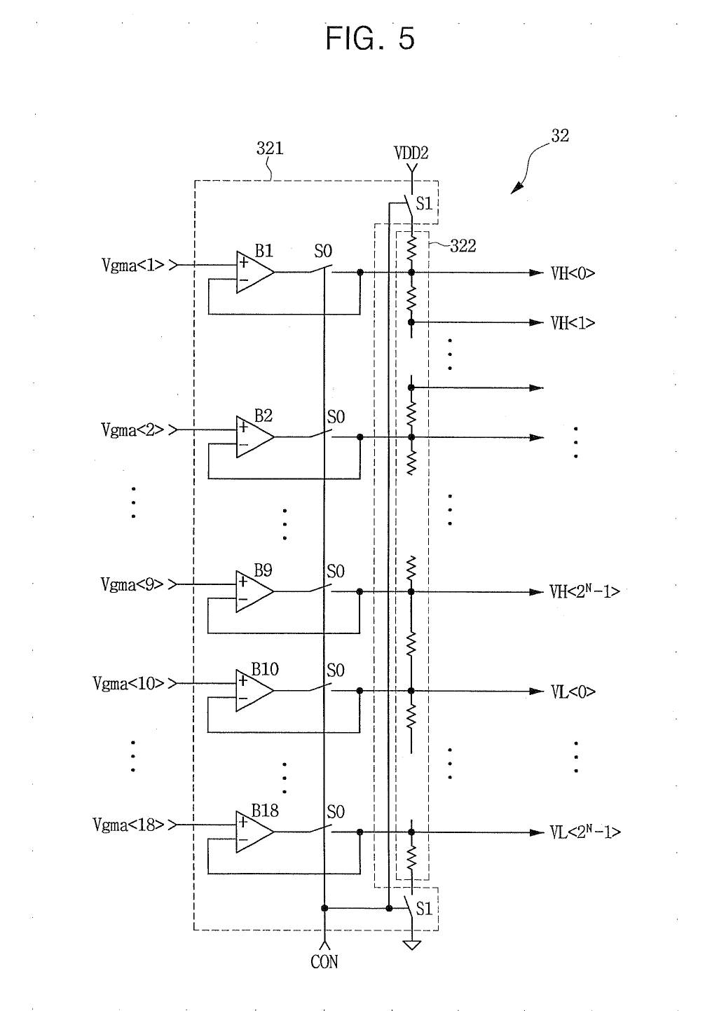

FIG. 5 is a circuit diagram illustrating an exemplary embodiment of a voltage generator 32 of the gamma voltage generator 30 of the source driver shown in FIG. 4. The voltage generator 32 may include a buffer unit 321 and a resistor string 322. The buffer unit 321 may include a plurality of buffers B1, B2, . . . B9, B10, . . . B18, a plurality of first switches S0, and a plurality of second switches S1. The resistor string 322 may include a plurality of resistors connected in series. Each of the gamma voltages VH<0:2^{N}−1>, VL<0:2^{N}−1> may be output at each of the nodes between two of the plurality of resistors of the resistor string 322.

The buffer unit 321 outputs each of the internal gamma voltages Vgma<1:18> output from the converter 31 to a corresponding node of the resistor string 322 or applies the power supply voltage VDD2 output from the power supply 10 to one end of the resistor string 322 in response to the control signal CON.

Each of the plurality of buffers B1, B2, . . . B9, B10, . . . B18 receives a corresponding internal gamma voltage of the plurality of internal gamma voltages Vgma<1:18> and outputs the corresponding internal gamma voltage to a corresponding node of the resistor string 322. Each of the first switches S0 is coupled between each of the plurality of buffers B1, B2, . . . B9, B10, . . . B18 and the corresponding node of the resistor string 322, which turns on and off in response to the control signal CON. Each of the second switches S1 is coupled between the resistor string 322 and the power supply voltage VDD2 or between the resistor string 322 and the ground voltage, which turns on and off in response to the control signal CON.

That is, the first switches S0 may be turned off when the control signal CON is deactivated to a low level and turned on when the control signal CON is activated to a high level, and the second switches S1 may be turned on when the control signal CON is deactivated to a low level and turned off when the control signal CON is activated to a high level. Therefore, the buffer unit 321 applies the power supply voltage VDD2 to one end of the resistor string 322 and the ground voltage to the other end of the resistor string 322 when the control signal CON is deactivated to a low level. Further, the buffer unit 321 applies each of the internal gamma voltages Vgma<1:18> to a corresponding node of the resistor string 322 when the control signal CON is activated to a high level.

The resistor string 322 may include a plurality of resistors connected in series between the second switches S1, which receives the internal gamma voltages Vgma<1:18> or the power supply voltage VDD2 and outputs the gamma voltages VH<0:2^{N}−1>, VL<0:2^{N}−1>. Each of the gamma voltages VH<0:2^{N}−1>, VL<0:2^{N}−1> may be output at each of the nodes between two of the plurality of resistors of the resistor string 322.

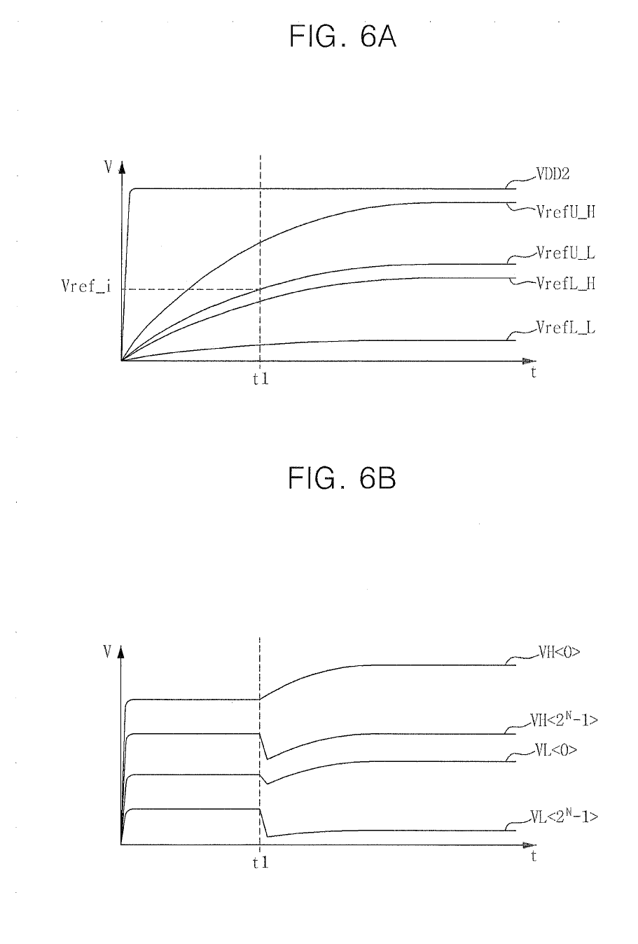

FIGS. 6(a) and 6(b) are timing diagrams for explaining the operation of a source driver according to exemplary embodiments. FIG. 6(a) is a timing diagram for explaining the operation of the power supply 10, and FIG. 6(b) is a timing diagram for explaining the operation of the gamma voltage generator 30. In FIG. 6(a), VDD2, VrefU_H, VrefU_L, VrefL_H, VrefL_L denote the power supply voltage and the reference voltages output from the power supply 10, and in FIG. 6(b) VH<0>, VH<2^{N}−1>, VL<0>, VL<2^{N}−1> denote the gamma voltages output from the gamma voltage generator 30.

As illustrated in FIG. 6(a), in the power-up operating mode, the power supply voltage VDD2 output from the power supply 10 has a relatively short delay time, and the reference voltages VrefU_H, VrefU_L, VrefL_H, VrefL_L have relatively long delay times.

Referring to FIG. 6(b), the gamma voltage generator 30 outputs the gamma voltages VH<0>, VH<2^{N}−1>, VL<0>, VL<2^{N}−1> using the power supply voltage VDD2 before a time point t1 at which a level of the reference voltage VrefU_L is equal to a level of the internal reference voltage Vref_i. Therefore, levels of the gamma voltages VH<0>, VH<2^{N}−1> do not have very small values even before a time point t1. After the time point t1 at which a level of the reference voltage VrefU_L is equal to a level of the internal reference voltage Vref_i, the gamma voltage generator 30 outputs the gamma voltages VH<0>, VH<2^{N}−1>, VL<0>, VL<2^{N}−1> using the reference voltages VrefU_H, VrefU_L, VrefL_H, VrefL_L.

In FIG. 6(b), only some of the gamma voltages VH<0:2^{N}−1>, VL<0:2^{N}−1> are shown for convenience of explanation, but the other gamma voltages may be output in the same way.

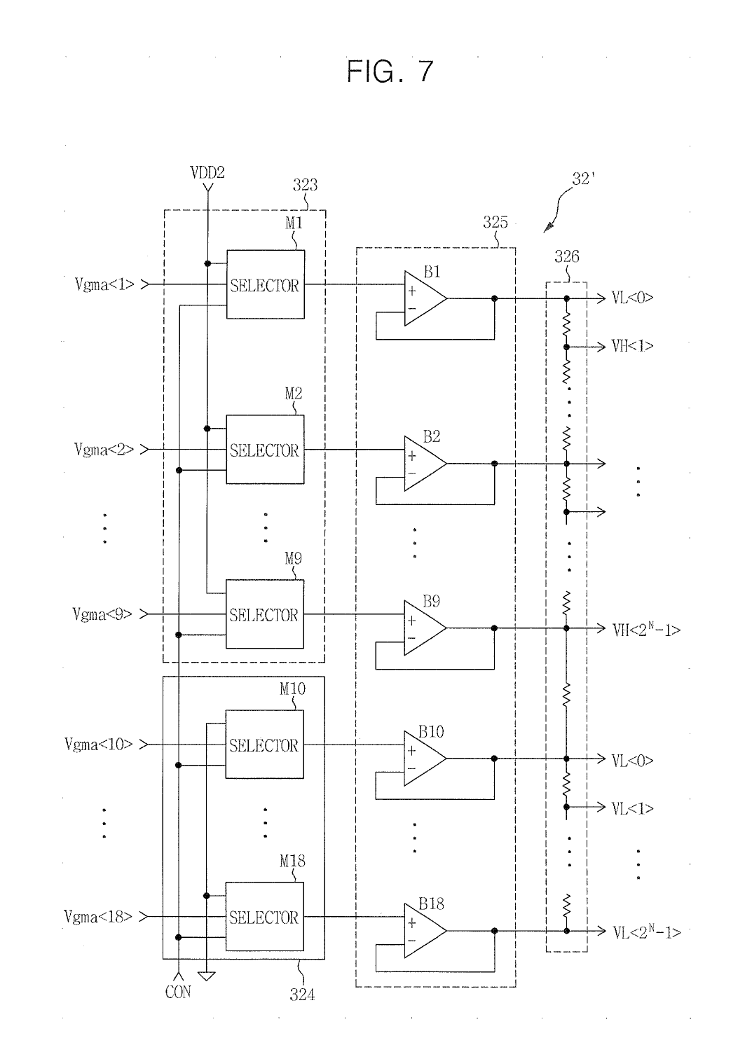

FIG. 7 is a circuit diagram illustrating an exemplary embodiment of a voltage generator 32′ which may replace the voltage generator 32 of the gamma voltage generator 30 of the source driver shown in FIG. 4. The voltage generator 32′ may include a first voltage selecting unit 323, a second voltage selecting unit 324, a buffer unit 325 and a resistor string 326. The first voltage selecting unit 323 may include a plurality of selectors M1, M2, . . . M9. The second voltage selecting unit 324 may include a plurality of selectors M10, . . . M18 The buffer unit 325 may include a plurality of buffers B1, B2, . . . B9, B10, . . . B18. The resistor string 326 may include a plurality of resistors connected in series to each other.

The first voltage selecting unit 323 selects and outputs the power supply voltage VDD2 or the first internal gamma voltages Vgma<1:9> in response to the control signal CON. Each of the selectors Ml, M2, . . . M9 of the first voltage selecting unit 323 selects and outputs the power supply voltage VDD2 or a corresponding internal gamma voltage of the first internal gamma voltages Vgma<1:9> in response to the control signal CON.

The second voltage selecting unit 324 selects and outputs the ground voltage or the second internal gamma voltages Vgma<10:18> in response to the control signal CON. Each of the selectors M10, . . . M18 of the second voltage selecting unit 324 selects and outputs the ground voltage or a corresponding internal gamma voltage of the second internal gamma voltages Vgma<10:18> in response to the control signal CON.

The buffer unit 325 applies voltages output from the first voltage selecting unit 323 and the second voltage selecting unit 324 to a corresponding node of the resistor string 326. Each of the buffers B1, B2, . . . B9, B10, . . . B18 receives a corresponding voltage of a plurality of voltages output from the first voltage selecting unit 323 and the second voltage selecting unit 324 to a corresponding node of the resistor string 326.

The resistor string 326 outputs a plurality of gamma voltages VH<0:2^{N}−1>, VL<0:2^{N}−1> in response to voltages received from the buffer unit 325.

That is, in the case of the voltage generator 32′ of the gamma voltage generator 30 of the source driver shown in FIG. 7, the first gamma voltages VH<0:2^{N}−1> have a level of the power supply voltage VDD2 and the second gamma voltages VL<0:2^{N}−1> have a level of the ground voltage for the stabilization time period (e.g., a time period during which a level of the reference voltage VrefU_L is lower than a level of the internal reference voltage Vref_i) in the power-up operating mode. That is, even in the power-up operating mode, the levels of the first gamma voltages VH<0:2^{N}−1> are not very small.

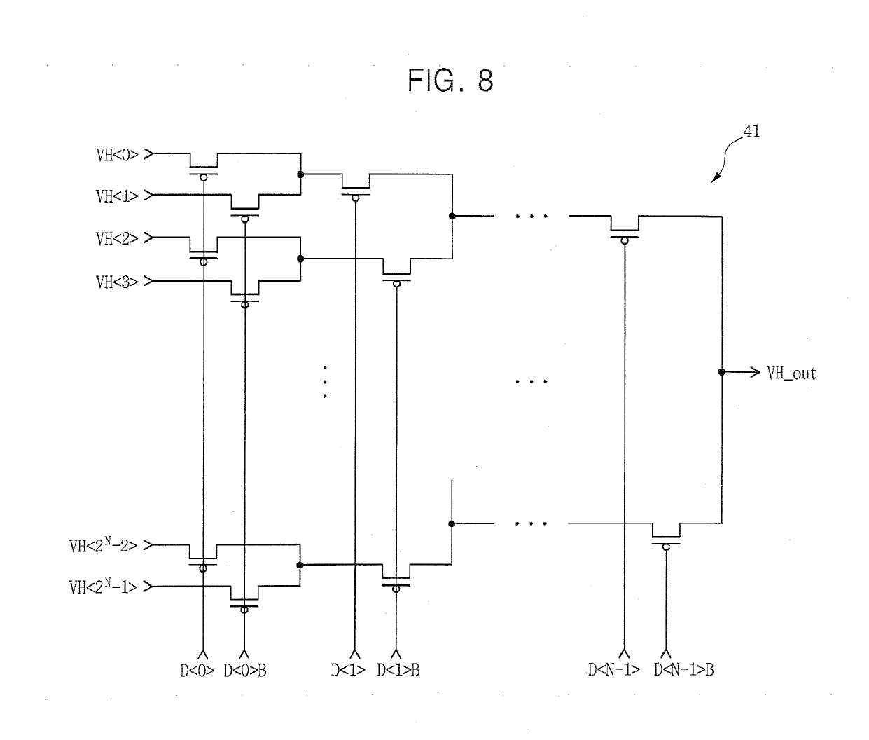

FIG. 8 is a circuit diagram illustrating an exemplary embodiment of a P decoder 41 of a decoding unit 40 of the source driver shown in FIG. 1. The P decoder 41 may include a plurality of PMOS transistors.

As shown in FIG. 8, the P decoder 41 may include a plurality of PMOS transistors having a gate to which a corresponding signal of data signals D<0:N−1> or inverted data signals D<0:N−1>B is applied, and would provide VH_out based upon first gamma voltages VH<0:2^{N}−1>.

The source driver according to exemplary embodiments, even in the power-up operating mode, may prevent damage to a PMOS transistor that may be caused by an increased voltage difference between a gate and a source when an excessively low voltage is applied to the source of the PMOS transistor.

On the other hand, N decoder 42 would similarly include a circuit (not shown but comparable to that shown in FIG. 8), except that a plurality of NMOS transistor would have a gate to which corresponding signal of data signals D<0:N−1> or inverted data signals D<0:N−1>B is applied, and would provide VL_out based upon second gamma voltages VL<0:2^{N}−1>.

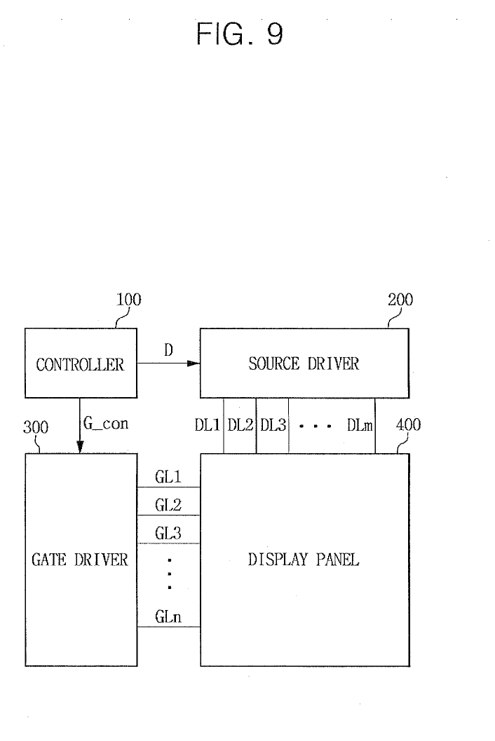

FIG. 9 is a block diagram illustrating a display device which includes the source driver according to an exemplary embodiment of the inventive concept. The display device may include a controller 100, a source driver 200, a gate driver 300 and a display panel 400.

The controller 100 may include a timing controller, which generates a gate control signal G_con and a data signal D.

The source driver 200 may implement at least one of the exemplary embodiments shown in FIG. 1 to FIG. 8, and drive data lines DL1, DL2, DL3, . . . DLm in response to the data signal D.

The gate driver 300 drives gate lines GL1, GL2, GL3, . . . GLn in response to the gate control signal G_con output from the controller 100.

The display panel 400 displays image information in response to voltages applied to the gate lines GL1, GL2, GL3, . . . GLn and the data lines DL1, DL2, DL3, . . . DLm.

Accordingly, a source driver and a display device according to at least one exemplary embodiment are capable of preventing damage to a decoder that may be generated in a power-up operating mode.

The foregoing is illustrative of exemplary embodiments and is not to be construed as limiting thereof. Although practical embodiments have been described, those skilled in the art will readily appreciate that many modifications are possible in the exemplary embodiments without materially departing from the novel teachings and advantages. Accordingly, all such modifications, as well as other embodiments, are intended to be included within the scope of the appended claims.

What is claimed is:

1. A source driver, comprising:
a power supply configured to generate a power supply voltage and a plurality of reference voltages, the power supply voltage being stabilized in a power-up operating mode and the plurality of reference voltages being stabilized after a stabilization time period has elapsed in the power-up operating mode; and
a gamma voltage output unit configured to generate a plurality of gamma voltages using the power supply voltage for the stabilization time period in the power-up operating mode, and to generate the plurality of gamma voltages using the plurality of reference voltages after the stabilization time period has elapsed.

2. The source driver according to claim 1, further comprising a decoding unit configured to select at least one voltage of the plurality of gamma voltages in response to a data signal.

3. The source driver according to claim 1, wherein the power supply generates the plurality of reference voltages using the power supply voltage.

4. The source driver according to claim 1, wherein the gamma voltage output unit includes:
a control signal generator configured to generate a control signal in response to a level of at least one reference voltage of the plurality of reference voltages; and
a gamma voltage generator configured to generate the plurality of gamma voltages using the power supply voltage or the plurality of the reference voltages in response to the control signal.

5. The source driver according to claim 4, wherein the control signal generator includes:
an internal reference voltage generator configured to generate an internal reference voltage based upon the power supply voltage; and
a comparing unit configured to compare a reference voltage of the plurality of reference voltages and the internal reference voltage to output the control signal that is activated when a magnitude of the reference voltage is greater than the internal reference voltage.

6. The source driver according to claim 4, wherein the gamma voltage generator includes:
a converter configured to generate a plurality of internal gamma voltages based upon the plurality of reference voltages;
a resistor string including a plurality of resistors, that is configured to output the gamma voltages at each of the nodes between two of the plurality of resistors; and
a buffer unit configured to apply the power supply voltage to a first end of the resistor string and to apply a ground voltage to a second end of the resistor string, or to apply each of the plurality of internal gamma voltages to a corresponding node of the nodes between two of the plurality of resistors of the resistor string in response to the control signal.

7. The source driver according to claim 4, wherein the gamma voltage generator includes:
a converter configured to generate first internal gamma voltages having relatively high voltage levels and second internal gamma voltages having relatively low voltage levels based upon the plurality of reference voltages;
a resistor string including a plurality of resistors, that is configured to output the gamma voltages at each of the nodes between two of the plurality of resistors;
a first selecting unit configured to select the first internal gamma voltages or the power supply voltage in response to the control signal;
a second selecting unit configured to select the second internal gamma voltages or a ground voltage in response to the control signal; and
a buffer unit configured to apply voltages output from the first selecting unit and the second selecting unit to a corresponding node of the nodes between two of the plurality of resistors of the resistor string.

8. A display device, comprising:
a controller configured to generate a gate control signal and a data signal;
a gate driver configured to drive gate lines in response to the gate control signal;
a source driver configured to drive data lines in response to the data signal; and
a display panel configured to display image information in response to signals applied to the gate lines and the data lines,
wherein the source driver includes:
a power supply configured to generate a power supply voltage and a plurality of reference voltages, the power supply voltage being stabilized in a power-up operating mode and the plurality of reference voltage being stabilized after a stabilization time period has elapsed in the power-up operating mode; and
a gamma voltage output unit configured to generate a plurality of gamma voltages using the power supply voltage for the stabilization time period in the power-up operating mode, and to generate the plurality of gamma voltages using the plurality of reference voltages after the stabilization time period has elapsed.

9. The display device according to claim 8, wherein the source driver further comprises a decoding unit including a plurality of decoders, the decoders being configured to select at least one voltage of the plurality of gamma voltages and drive a corresponding data line of the data lines in response to the data signal.

10. The display device according to claim 8, wherein the power supply generates the plurality of reference voltages using the power supply voltage.

11. The display device according to claim 8, wherein the gamma voltage output unit includes:
a control signal generator configured to generate a control signal in response to a level of at least one reference voltage of the plurality of reference voltages; and
a gamma voltage generator configured to generate the plurality of gamma voltages using the power supply voltage or the plurality of the reference voltages in response to the control signal.

12. The display device according to claim 11, wherein the control signal generator includes:
an internal reference voltage generator configured to generate an internal reference voltage based upon the power supply voltage; and
a comparing unit configured to compare a reference voltage of the plurality of reference voltages and the internal reference voltage to output the control signal that is activated when a magnitude of the reference voltage is greater than the internal reference voltage.

13. The display device according to claim 11, wherein the gamma voltage generator includes:
a converter configured to generate a plurality of internal gamma voltages based upon the plurality of reference voltages;
a resistor string including a plurality of resistors, that is configured to output the gamma voltages at each of the nodes between two of the plurality of resistors; and
a buffer unit configured to apply the power supply voltage to a first end of the resistor string and to apply a ground voltage to a second end of the resistor string, or to apply each of the plurality of internal gamma voltages to a corresponding node of the nodes between two of the plurality of resistors of the resistor string.

14. The display device according to claim 11, wherein the gamma voltage generator includes:
a converter configured to generate first internal gamma voltages having relatively high voltage levels and second internal gamma voltages having relatively low voltage levels based upon the plurality of reference voltages;
a resistor string including a plurality of resistors, that is configured to output the gamma voltages at each of the nodes between two of the plurality of resistors;
a first selecting unit configured to select the first internal gamma voltages or the power supply voltage;
a second selecting unit configured to select the second internal gamma voltages or a ground voltage; and
a buffer unit configured to apply voltages output from the first selecting unit and the second selecting unit to a corresponding node of the nodes between two of the plurality of resistors of the resistor string.

15. A gamma voltage generation apparatus for a display device comprising:
a supply voltage generator that provides a power supply voltage that is stabilized to a predetermined power supply voltage level during substantially an entire power-up operating mode;
a reference voltage generator coupled between an output of the supply voltage generator and ground, the reference voltage generator comprising:
a plurality of resistors coupled in series between the output of the supply voltage generator and ground, and
a plurality of capacitors, each capacitor coupled between a respective pair of the resistors and ground,
wherein a respective reference voltage is output from each respective node between two of the plurality of resistors, and
wherein each reference voltage reaches a respective reference voltage level during a respective stabilization time period during the power-up operating mode,
a gamma voltage generator that generates a plurality of gamma voltages using the power supply voltage or the reference voltages; and
a control signal generator that controls the use of the power supply voltage by the gamma voltage generator prior to a predetermined time point at which the levels of the reference voltages are stabilized, and controls the use of the reference voltages by the gamma voltage generator after the predetermined time point has passed.

16. The gamma voltage generation apparatus of claim 15, wherein the stabilization time period for each of the reference voltages is different from each other.

17. The gamma voltage generation apparatus of claim 15, wherein each of the capacitors have substantially the same capacitance.
